(19) United States
(12) Patent Application Publication
(10) Pub. No.: US 2006/0109909 A1
(43) Pub. Date: May 25, 2006

(54) DECISION MECHANISM FOR PARTITION TYPES OF MACRO BLOCK

(76) Inventors: Chih-Feng Chang, Hsinchu City (TW); Chun-Liang Tu, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/905,678

(22) Filed: Jan. 17, 2005

(30) Foreign Application Priority Data
Nov. 19, 2004 (TW) 93135544

(51) Int. Cl. H04N 11/04; H04N 11/02; H04N 7/12; H04B 1/66

(52) U.S. Cl. 375/240.17; 375/240.24; 375/240.16

(57) ABSTRACT

A decision mechanism for partition types of a macro block is provided. First, a rough motion estimation is performed on a macro block, so as to obtain a rough related information corresponding to various partition types. Then, one of the partition types is determined based on the rough related information. Afterwards, a fine related information is obtained by performing a fine motion estimation with the determined partition type on the macro block. Wherein, the increased pixel shift of the fine motion estimation is smaller than the increased pixel shift of the rough motion estimation. Accordingly, the decision mechanism for partition types of the macro block can reduce the motion estimation time and provide higher processing efficiency.

### CROSS-REFERENCE TO RELATED APPLICATION

This application claims the priority benefit of Taiwan application serial no. 93135544, filed on Nov. 19, 2004.

### BACKGROUND OF THE INVENTION

1. Field of the Invention

The present invention relates to a video coding method, and more particularly, to a decision mechanism for partition types of a macro block.

2. Description of the Related Art

Since digital video data are usually in an excessively huge amount, in order to save the space for storing video data and to reduce the transmission bandwidth when transmitting video data, video data are usually compressed before they are transmitted. The commonly used data compression method removes redundant information from video data, so that the data amount is reduced. For example, if the content of a subsequent frame is similar to the content of a previous frame, the same portion in the subsequent frames can be removed and only the different portions are reserved. Therefore, the data amount of the digital video is significantly reduced.

A macro block was used as unit in the conventional motion estimation. In order to obtain better image quality, both of the new generation techniques including the Advanced Video Coding (AVC/H.264) divide a macro block into a plurality of smaller sub-blocks, and the smaller sub-block is used as unit for performing the motion estimation. In general, there are many different partition types for a macro block, wherein better partition type can provide better image quality and processing speed. Contrarily, inadequate partition type doses not only reduce the processing speed, but also deteriorate the image quality.

FIG. 1 schematically shows a flow chart illustrating a conventional decision mechanism for partition types of a macro block.

In the conventional technique, first, an integer motion estimation with various partition types is performed on a macro block (step 102). Wherein, the “integer motion estimation” means that the increased distance obtained from searching in the comparison frame is equal to an integral multiple times of pixels. In other words, the amount of the pixel shift is an integer. Therefore, the related information obtained from searching is a rough estimation result.

Then, a decimal motion estimation with various partition types mentioned above is performed on a macro block (step 104). Wherein, the “decimal motion estimation” means that the increased distance obtained from searching in the comparison frame is less than one pixel. In other words, the amount of the pixel shift is a decimal, and the related information obtained from searching is a fine estimation result. In general, the related information comprises a motion vector of the compared image block corresponding to the current image frame and a corresponding cost.

Then, a partition type is determined based on the fine estimation result (i.e. the related information) (step 106). Wherein, a partition type with minimum cost is selected as an optimal partition type by comparing the cost of each partition type, and at the same time the corresponding motion vector is obtained.

However, in the decision mechanism for partition types mentioned above, the optimal partition type is determined after performing both the integer motion estimation and the decimal motion estimation on each partition type. Therefore, it does not only take a great amount of estimation time, but also deteriorate the system processing efficiency.

### SUMMARY OF THE INVENTION

Therefore, it is an object of the present invention to provide a decision mechanism for partition types of a macro block in order to obtain better processing speed and image quality.

In order to achieve the object mentioned above and others, the present invention provides a decision mechanism for partition types of a macro block. First, a rough motion estimation is performed on a macro block, so as to obtain a rough related information with various partition types. Then, one of the partition types is determined based on the rough related information. Afterwards, a fine related information is obtained by performing a fine motion estimation with the determined partition type on the macro block. Wherein, an increased pixel shift of the fine motion estimation is smaller than an increased pixel shift of the rough motion estimation.

In a preferred embodiment of the present invention, each of the rough related information mentioned above comprises a motion vector and a corresponding cost. In addition, a corresponding partition type with minimum cost is selected based on the related information.

In a preferred embodiment of the present invention, the fine related information mentioned above may include a motion vector.

In a preferred embodiment of the present invention, the increased pixel shift of the rough motion estimation is for example an integer. In addition, the increased pixel shift of the fine motion estimation is for example a decimal.

In summary, the fine motion estimation with the optimal partition type is performed on the macro block after the optimal partition type is determined in the present invention. Therefore, comparing with the conventional motion estimation method, the present invention reduces the estimation time and further improves the system processing efficiency and image quality.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a flow chart illustrating a conventional decision mechanism for partition types of a macro block.

FIG. 2 schematically shows a flow chart illustrating a decision mechanism for partition types of a macro block according to the present invention.

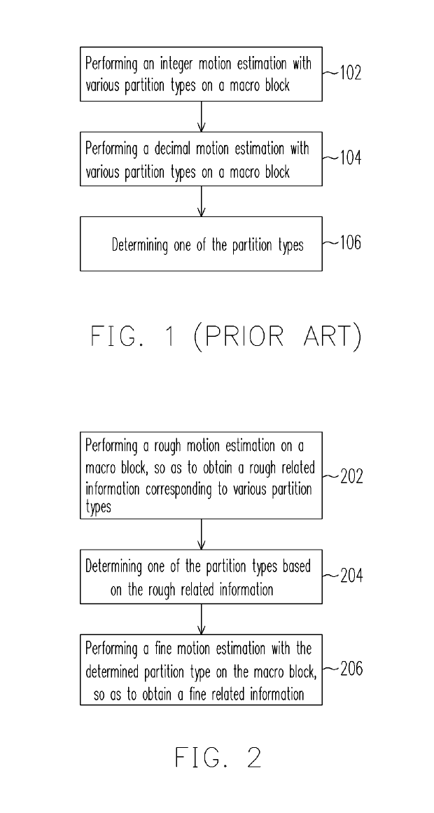

### DESCRIPTION OF THE PREFERRED EMBODIMENTS

Referring to FIG. 2, which schematically shows a flow chart illustrating a decision mechanism for partition types of a macro block according to the present invention.

First, a rough motion estimation is performed on a macro block, so as to obtain a rough related information with various partition types (step 202). Wherein, the rough related information comprises a macro block motion vector and its corresponding cost. In an embodiment of the present invention, the size of the image block is for example 16×16 or 8×8. In the frame for comparison, a center point, which is at the same location of the current image block, is gradually increased with a predetermined distance. Wherein, the area formed is referred to as a “search window”, and the increased predetermined distance is refereed to as a “search range” herein, which is for example counted by units of the pixel shifts. In an embodiment of the present invention, the increased pixel shift of the rough motion estimation is for example a plurality of integral pixels, which indicates that it is an integer motion estimation.

Specifically, a compared image block (whose size is the same as the size of the current image block) arbitrarily selected from the search window is compared with the current image block, so as to find an image block with the most similar content. Wherein, when comparing the current image block with the compared image block, a cost operation is usually performed on both image blocks, and the similarity of the current image block to the compared image block is determined based on the cost.

Then, a partition type is determined as an optimal partition type based on the rough related information (step 204). Wherein, the way of determining the optimal partition type is for example comparing the cost of each partition type, and selecting a corresponding partition type with minimum cost as the optimal partition type.

Afterwards, a fine motion estimation with the determined partition type is performed on the macro block, so as to obtain a fine related information (step 206). Wherein, the rough related information obtained from the rough motion estimation in step 202 is approaching toward the location of the most similar image block now. Therefore, in the fine motion estimation, the current image block is compared with the compared image block by gradually shifting with a smaller predetermined distance from a center point pointed by the rough related information, so as to obtain finer related information, such as the motion vector.

In addition, the increased pixel shift of the fine motion estimation is smaller than the increased pixel shift of the rough motion estimation. For example, the fine motion estimation is for example a decimal motion estimation. In other words, the increased distance for searching is less than one pixel. Of course, the rough motion estimation performed by the present invention is not necessarily limited to the integer motion estimation, and the fine motion estimation is not necessarily limited to the decimal motion estimation. An appropriate increased distance for searching may be selected in consideration of both the motion estimation performance and the allowable error range, such that a better balance point between the motion estimation speed and the accuracy can be obtained.

Note that a motion estimation for one of the macro blocks in the frame is exemplified for explanation of the embodiment mentioned above. However, in a complete motion estimation process, all of the macro blocks (herein referred to as the current image block) are sequentially selected from the frame, and the divided sub-block is used as a unit for comparing with the compared image block in the compared frame by sequentially performing the steps mentioned above, so as to search and determine whether there is a compared image block having similar content or not.

In summary, in the decision mechanism for partition types of a macro block provided by the present invention, first, a rough motion estimation is performed on the macro block, so as to obtain a rough related information corresponding to various partition types, and an optimal partition type is selected based on the rough related information. Then, a fine motion estimation with the optimal partition type is performed on the macro block. Therefore, comparing with the conventional decision mechanism which performs both the integer motion estimation and the decimal motion estimation on various partition types, the present invention effectively reduces the motion estimation time and further improves the system processing efficiency and image quality.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A decision mechanism for partition types of a macro block, comprising:
performing a rough motion estimation on a macro block, so as to obtain a rough related information corresponded to a plurality of different partition types;
determining one of the partition types based on the rough related information; and
performing a fine motion estimation with the determined partition type on the macro block, so as to obtain a fine related information, wherein an increased pixel shift of the fine motion estimation is smaller than an increased pixel shift of the rough motion estimation.

2. The decision mechanism for partition types of the macro block of claim 1, wherein each of the rough related information comprises a motion vector and a corresponding cost.

3. The decision mechanism for partition types of the macro block of claim 2, wherein a corresponding partition type with minimum cost is selected among the partition types based on the related information.

4. The decision mechanism for partition types of the macro block of claim 1, wherein the fine related information comprising a motion vector.

5. The decision mechanism for partition types of the macro block of claim 1, wherein the increased pixel shift of the rough motion estimation comprises an integer.

6. The decision mechanism for partition types of the macro block of claim 1, wherein the increased pixel shift of the fine motion estimation comprises a decimal.
